(19) United States
(12) Patent Application Publication
(10) Pub. No.: US 2006/0066439 A1
(43) Pub. Date: Mar. 30, 2006

(54) Smart key entry system

(76) Inventors: Thomas Keeling, Redford, MI (US); Akio Nakano, West Bloomfield, MI (US); Keiichi Aoyama, Novi, MI (US); Michael Wiegand, Birmingham, MI (US); Justin McBride, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 10/949,453

(22) Filed: Sep. 24, 2004

(51) Int. Cl. H04Q 1/00; G05B 19/00

(52) U.S. Cl. 340/5.61; 340/5.72

(57) ABSTRACT

A smart key entry system for unlocking a plurality of doors in a platform includes a controller within the platform. The controller is operable to lock and unlock each of the plurality of doors. A sensor is located on each of the plurality of doors. Each sensor is operable to communicate to the controller when a user has activated the sensor. A mobile device external to the platform is operable to wirelessly communicate with the controller when within a detection area surrounding the platform. If the mobile device is within the detection area, the controller unlocks a door when the sensor located on the door communicates to the controller that a user has activated the sensor.

### FIELD OF THE INVENTION

The present invention relates to an entry system for a platform, and more particularly to a smart key entry system for unlocking a plurality of doors in a platform.

### BACKGROUND OF THE INVENTION

“Smart Key” entry systems are new devices that employ modern wireless technology in order to unlock a platform, typically a motor vehicle. In a typical “Smart Key” system, the motor vehicle periodically transmits an interrogation signal therefrom. The range of the interrogation signal defines a detection area around the motor vehicle. The “Smart Key” itself is typically an electronic key housing a transceiver. As the “Smart Key” enters the detection area around the motor vehicle, it receives the interrogation signal. The “Smart Key” responds by transmitting an identification code that is unique to the motor vehicle. A controller in the motor vehicle compares this identification code to its corresponding code to determine if the owner of the motor vehicle is within the detection area. If the codes match, the motor vehicle enters an unlock-standby state. If the owner then touches one of the doors in the unlock-standby state, the doors are unlocked in response to a detection of the touch via a touch sensor. Additionally, steering wheel locks or engine locks may also be employed with a “Smart Key” system.

While current “Smart Key” systems are suitable for their intended purpose, there is room in the art for improvement. Accordingly, the present invention provides a smart key entry system for unlocking various doors on a platform using signals from the user of the smart key entry system.

### SUMMARY OF THE INVENTION

A smart key entry system for unlocking a plurality of doors in a platform includes a controller within the platform. The controller is operable to lock and unlock each of the plurality of doors. A sensor is located on each of the plurality of doors. Each sensor is operable to communicate to the controller when a user has activated the sensor. A mobile device external to the platform is operable to wirelessly communicate with the controller when within a detection area surrounding the platform. If the mobile device is within the detection area, the controller unlocks a door when the sensor located on the door communicates to the controller that a user has activated the sensor.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is an exemplary view of a platform employing a smart key entry system constructed according to the principles of the present invention;

FIG. 2 is a schematic diagram of the smart key entry system of the present invention;

FIG. 3 is a flow chart illustrating the operation of the smart key entry system of the present invention; and

FIG. 4 is a flow chart illustrating an alternate operation of the smart key entry system of the present invention.

### DETAILED DESCRIPTION OF THE PREFERRED EMBODIMENTS

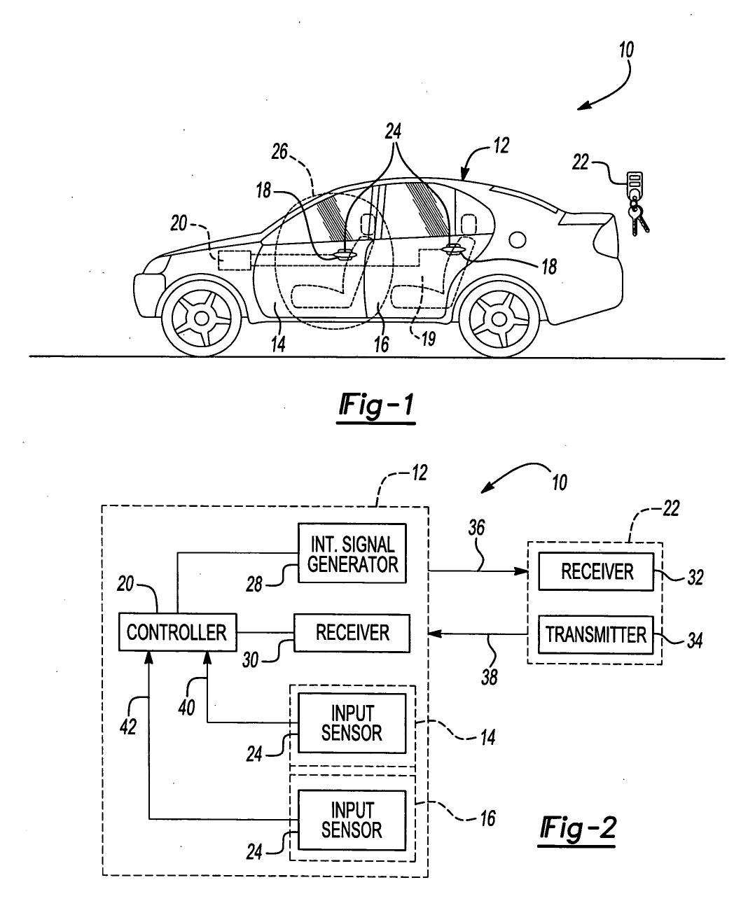

With reference to FIG. 1, a smart key entry system constructed according to the principles of the present invention is generally indicated by reference numeral 10. The smart key entry system 10 is shown in operable association with an exemplary motor vehicle 12. It should be appreciated, however, that the smart key entry system 10 may be used in conjunction with any platform, including an aircraft or a non-mobile structure. In the particular example provided, the motor vehicle 12 includes a plurality of four doors including a driver door 14 and passenger doors 16. Each door 14, 16 includes a door handle 18. Each door handle 18 may further include a display that indicates the status of the door such as, for example, “locked” and “unlocked”.

The smart key entry system 10 includes a controller 20, a mobile device 22, and a plurality of input sensors 24. The controller 20 is located within the motor vehicle 12 and is operable to lock and unlock each of the doors 14, 16. The mobile device 22 includes a transmitter capable of wirelessly communicating with the controller 20 as will be described in greater detail below. The plurality of input sensors 24 are accessible outside of an interior compartment 23 of the motor vehicle 12. For example, the input sensors 24 may be located in or proximate to each of the door handles 18. The input sensors 24 are also electrically connected to the controller 20. In an exemplary embodiment, the input sensors 24 are touch sensors that sense the touch of an intended entrant. It is envisioned that other types of sensor are also within the scope of the present invention.

Generally speaking, the motor vehicle 20 has a detection area 26 surrounding the motor vehicle 20. In the particular example provided, the detection area 26 is localized around the door 14. The detection area 26 preferably has a semi-spherical shape that projects outward from the door 14. Moreover, each door 14, 16 has its own localized detection area 26, though for purposes of clarity only one detection area 26 has been illustrated in FIG. 1. Alternatively, a single large detection area that encompasses the entire motor vehicle 12 could also be used. When the mobile device 22 enters the detection area 26, the mobile device 22 communicates with the controller 20 via a wireless communication link. If one of the sensors 24 then communicates to the controller 20 that a user is touching the sensor 24, the controller 20 unlocks the door 14, 16 corresponding to the sensor 24 that was touched. In the conventional approach, only the door 14, 16 whose sensor 24 was activated by a user is unlocked.

Turning now to FIG. 2, the smart key entry system 10 will be described in greater detail. The smart key entry system 10 further includes an interrogation signal generator 28 and a receiver 30 located within the motor vehicle 12. The interrogation signal generator 28 and the receiver 30 are each in data communication with the controller 20. Likewise, a receiver 32 and a transmitter 34 are located within the mobile device 22.

The interrogation signal generator 28 generates and periodically transmits an interrogation signal 36 outside of the motor vehicle 12. The range of the interrogation signal 36 defines the detection area 26 (FIG. 1) of the motor vehicle 12. If the mobile device 22 is within the detection area 26, the receiver 32 located therein will receive the interrogation signal 36. In response, the transmitter 34 will transmit an identification signal 38. The identification signal 38 embodies a unique identification number. The identification signal 38 is received by the receiver 30 located within the motor vehicle 12. The controller 20 then compares the identification number from the identification signal 38 to a unique identification number assigned to the motor vehicle 12 to determine if the mobile device 22 is the smart key to the motor vehicle 12. If the identification numbers match, then the controller 20 is capable of unlocking the doors 14, 16. This identification signal may be referred to as an entrant verification message.

Meanwhile, the input sensor 24 located on the driver door 14 is operable to send an input signal 40 to the controller 20 if a user activates the input sensor 24. Likewise, the input sensor 24 located on the passenger door 16 is operable to send an input signal 42 to the controller 20 if a user activates the input sensor 24. Essentially, then, the input signals 40, 42 indicate that an entrant is in close proximity to the motor vehicle (e.g., in order to activate the sensors 24, an entrant must be within range to activate or be sensed by the sensors) and that an entrant desires to unlock a given door 14, 16.

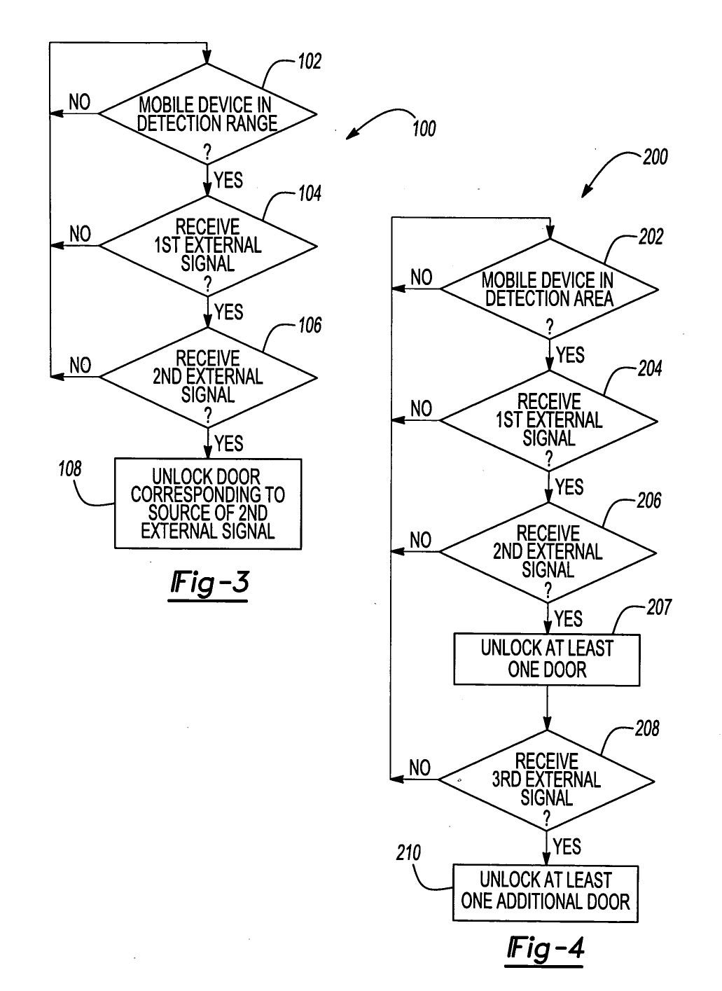

Referring to FIG. 3, a conventional operation 100 for the smart key entry system 10 is further described below. Processing cycles until such time as the mobile device 22 moves within the detection range 26 at step 102. If the mobile device 22 is within the detection range 26, the mobile device 22 sends a first external signal to the controller 20 at step 104. The first external signal serves as an entrant verification message.

Next, the controller 20 receives a second external signal at step 106. The second external signal corresponds to an input signal 40, 42 from a sensor positioned proximate to one of the doors 14, 16, and thus is received from a source external to the interior compartment 19 of the motor vehicle 12. The controller 20 at step 108 then unlocks whichever door 14, 16 is adjacent to the sensor that sent the input signal. This approach does not provide an easy means for unlocking any or all of the other vehicle doors.

In accordance with the present invention, an improved method is provided for unlocking the remaining doors of a vehicle as shown in FIG. 4. Operation 200 for the smart key entry system 10 cycles until such time as the mobile device 22 moves within the detection range 26 at step 202. If the mobile device 22 is within the detection range 26, the mobile device 22 sends a first external signal to the controller 20 at step 204. The first external signal again serves as an entrant verification message.

Next, the controller 20 receives a second external signal at step 206. The second external signal corresponds to an input signal 40, 42 from a sensor placed proximate to one of the doors 14, 16, and thus is received from a source external to the interior compartment 19 of the motor vehicle 12. Upon receipt of this second external signal, the controller 20 then awaits for a third external signal at step 208 before any doors 14, 16 are unlocked.

The third external signal corresponds to a second input signal sent from one of the sensors 24 to the controller 20. However, a second input signal processed as the third external signal only under specific conditions. For instance, when an input sensor 24 is activated within a certain timeframe of the first activation (i.e. within a certain period of time from receipt by the controller 20 of the second external signal at step 206), then the received input signal is processed by the controller 20 as a third external signal. It is envisioned that the sensor may be activated only by a predefined number of touches (e.g., two successive touches). It is further envisioned that the second activation of an input sensor 24 may be restricted to the same door as the first activation or may be extended to an input signal received from a different door. In another instance, an input signal generated by continuously touching an input sensor 24 for a given period of time may constitute the third external signal. In yet another instance, an input signal generated by pushing in a door handle may constitute the third external signal. It is readily understood that other conditions for generating a third external signal fall within the scope of the present invention.

The controller 20 at step 210 then unlocks whichever doors 14, 16 have sent a third external signal. Only the door proximate to the sensor which sent the third external signal is unlocked. Various other conditions may be required before the third external signal is processed. For example, a precondition may include the requirement that the door 14, 16 must be opened before the third external signal is sent

Alternatively, upon receipt of the second external signal, the controller 20 may unlock a single door corresponding to either the driver door or the source of the second external signal as indicated at step 207. Upon receipt of the third external signal, an action is then taken in relation to the remaining locker doors. For example, upon receipt of the third external signal, doors on the same side of the vehicle as the activated sensor or all of the remaining locked doors may be unlocked by the controller.

The smart key entry system 10 expands conventional entry systems by tailoring the unlocking of a specific door to only those doors that need to be unlocked by a given user. By requiring a third activation signal, the smart key entry system 10 can further ensure that a given door is unlocked only when intended to be so by the user.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for unlocking doors to an interior compartment of a mobile platform, comprising:
receiving an entrant verification message;
receiving a first signal from a sensor accessible outside of the interior compartment of the mobile platform, wherein the first signal indicates an entrants proximity to the interior compartment;
receiving a second signal subsequent to receipt of the first signal; and
unlocking at least two doors to the interior compartment in response to the first and second signals.

2. The method of claim 1 wherein receiving the first signal further comprises disposing the sensor proximate to a given door to the interior compartment such that the first signal indicates the entrant's desire to unlock the given door.

3. The method of claim 2 wherein the first signal indicates the entrant is touching a handle for the given door.

4. The method of claim 1 wherein the second signal is transmitted from the sensor.

5. The method of claim 2 wherein the second signal indicates the entrant is touching the handle for the given door a second time.

6. The method of claim 2, wherein the second signal indicates the entrant is continuously touching the given door for a period of time.

7. The method of claim 2 wherein the second signal indicates a second entrant is touching a handle for a door other than the given door.

8. The method of claim 7 further comprising receiving an entrant verification message from the second entrant.

9. The method of claim 1 wherein the second signal is transmitted from a different sensor accessible outside of the interior compartment of the mobile platform.

10. The method of claim 1 wherein the entrant verification message includes an identification number to the mobile platform unique to the mobile platform.

11. The method of claim 1 wherein the entrant verification message is transmitted via a wireless communication link.

12. An entry system for unlocking doors to an interior compartment of a motor vehicle, comprising:
a controller operable to unlock the doors; and
a first sensor coupled to the motor vehicle and accessible outside of the interior compartment of the motor vehicle, the sensor operable to transmit a first signal to the controller indicating an entrants proximity to the interior compartment and operable to transmit a second signal to the controller indicating an entrant's desire to unlock a given door;
wherein the controller unlocks at least the given door in response to receipt of the first and second signals.

13. The entry system of claim 12, further comprising a remote device operable to transmit a third signal to the controller, wherein the controller unlocks at least the given door in response to receipt of the first, second, and third signals.

14. The entry system of claim 12, wherein the controller unlocks all the doors to the interior compartment of the motor vehicle in response to receipt of the first and second signals.

15. The entry system of claim 12, wherein the sensor is a touch sensor operable to sense the touch of an entrant.

16. The entry system of claim 15, wherein the sensor is located in a handle of the given door.

17. The entry system of claim 16, further comprising a second sensor located in a handle of a door other than the given door and operable to transmit the second signal to the controller, and wherein the controller unlocks at least one door.

18. A method for unlocking a door to an interior compartment of a motor vehicle other than the driver's door, comprising:
receiving a first signal from a touch sensor located on a door to the interior compartment, wherein the first signal indicates an entrant's touching of the touch sensor;
receiving a second signal subsequent to receipt of the first signal from a touch sensor located on a different door to the interior compartment, wherein the second signal indicates an entrant's desire to unlock the door; and
unlocking the door to the interior compartment in response to the first and second signals.

19. The method of claim 18, wherein the second signal is transmitted from the sensor and the door and the different door are the same door.

20. The method of claim 18, further comprising receiving a third signal from a remote device indicating an entrants proximity to the motor vehicle, and unlocking the different door to the interior compartment in response to the first, second, and third signals.

21. A method for unlocking a door to an interior compartment of a motor vehicle other than the driver's door, comprising:
receiving an entrant verification message;
receiving a first signal from a remote device indicating an entrant's proximity to the motor vehicle;
receiving a second signal from a sensor located on a given door to the interior compartment other than the driver's door, wherein the second signal indicates an entrant's proximity to the given door; and
unlocking at least the given door to the interior compartment in response to the first and second signals.

22. The method of claim 21 further comprises unlocking all of the doors to the motor vehicle in response to the first and second signals.
